(19) United States
(12) Patent Application Publication
(10) Pub. No.: US 2011/0225188 A1
(43) Pub. Date: Sep. 15, 2011

(54) METHOD AND SYSTEM FOR PROCESSING TRAVEL-RELATED DATA

(75) Inventor: Christopher Lopinto, Port Jefferson, NY (US)

(73) Assignee: Expert Travel Services, LLC, Patchogue, NY (US)

(21) Appl. No.: 13/045,677

(22) Filed: Mar. 11, 2011

Related U.S. Application Data
(60) Provisional application No. 61/313,447, filed on Mar. 12, 2010.

(51) Int. Cl. G06F 17/30

(52) U.S. Cl. 707/770; 707/E17.014

(57) ABSTRACT

A method and system for querying travel-related data wherein a computer-readable storage medium comprises one or more programming instructions for: receiving a request for flight information; searching a plurality of Global Distribution System (GDS) databases or at least one airline database directly in accordance with the request; sending at least one result from the plurality of GDS databases corresponding to the request, the at least one result including at least one of an available flight upgrade or an available flight award; and sending at least one result from the plurality of GDS databases corresponding to the plurality of requests for alerts related to availability of a seat upgrade, availability of a flight upgrade, and/or availability of further flight rewards.

### PRIORITY

This application claims priority to a United States provisional patent application filed on Mar. 12, 2010 titled “METHOD AND SYSTEM FOR PROCESSING TRAVEL-RELATED DATA” and assigned U.S. Provisional Patent Application Ser. No. 61/313,447; the entire contents of which are incorporated herein by reference.

### BACKGROUND

1. Field of Related Art

The present disclosure is generally related to processing of travel-related data, and more particularly, to a system and method for providing users with available flight upgrades, available flight awards, flight alerts, and/or seat alerts.

2. Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Generally, in a frequent flyer mile award/upgrade program, a passenger enrolled in such program may be able to use his/her accrued frequent flyer miles to purchase flight awards/upgrades. Certain frequent flyer passengers become eligible to receive a certain number of awards/upgrades for free. Airlines also create different award/upgrade programs for their corporate customers, both as a customary gesture and in exchange for return of frequent flyer miles. All these reward/upgrade programs try to utilize the unsold first and business cabin seats to generate monetary or non-monetary benefits for the airline. However, none of these award/upgrade programs provides a solution that may optimally utilize all of the unsold first cabin seats. Even today, there are flights that still fly with empty first and business cabin seats.

It is very uncertain and difficult to predict at the outset exactly how much demand exists for first cabin seats at the given travel prices. Consequently, it is difficult for an airline to accurately know the capacity sold and unsold until the last few minutes prior to departure. The problem becomes even worse as several booked first cabin passengers do not finally turn up for the flight (so-called “no shows”) or due to those passengers who cancel their trips at the last minute. The exact availability of first cabin seats may be known only minutes before departure, once the airline stops taking any additional passengers for the first cabin. At that point, however, an airline doesn't have much time to find potential passengers and process upgrades to fill the unused first cabin seats. The airlines are under the gun to fly on schedule. A short delay in the departure of one flight may reverberate throughout the system and delay several other flights, leading to huge costs and customer ill-will.

Booking an airline flight requires access to flight availability data, such as flight schedules and availability of seats. This information is updated and controlled by airlines and available from the airline servers. In the past, only travel agents and airline personnel had access to airline servers and flight availability data. Computer systems allowed travel agents to be networked to airline servers through proprietary networks not available to individual clients. The proprietary networks were typically operated by travel information providers who provided electronic distribution of travel information to subscribing travel agencies. This limited access to airline servers and placed burdens on them.

However, with the ever increasing use of the Internet, many Internet web sites have been developed that also subscribe to services provided by travel information providers and allow individual clients to request flight availability data. When travel information providers receive flight availability data requests from their subscribers, they typically access airline servers in order to fulfill those requests.

Independent travel service providers (e.g., Orbitz, Inc., Expedia, Inc.) are travel service sellers that are not related to only one travel service provider. Since they are not related to only one travel service provider, such sellers may generate travel options from many different travel service providers, giving a customer a broader selection of choices. Travel options include itineraries for which a fare may be generated. Independent travel service providers generally, use automated systems, accessible over the Internet, to determine travel options by applying fares to scheduling information such as flights, routes, itineraries and so forth. Application of fares to scheduling information involves use of certain rules. These rules are used to determine, for example whether a fare may be used for a particular passenger itinerary.

To compete for business and to try to retain travelers, travel service providers have developed frequent traveler programs where the traveler receives some award credit (e.g., miles) or upgrade for travel with a particular travel service provider. These frequent travel programs allow the traveler to redeem this award credit or upgrade credit for free tickets, further upgrades, and other services. In some cases, travel service providers have partnered with one or more other travel service providers to increase the benefits of the frequent traveler programs by allowing both award credit and/or redemption to be given by the partners. Typically, to redeem the award credit or upgrade credit that a traveler has accumulated, the traveler calls a customer service representative of the travel service provider. However, Internet travel service providers do not automatically calculate travel availability for redemption of accumulated award credit or upgrade credit in frequent traveler programs.

Accordingly, there is need in the art for a mechanism that allows customers to satisfy their need for flexibility at terms that concurrently benefit both companies and their customers.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

A system is presented for querying travel-related data, including a processor and a non-transitory, computer-readable storage medium in communication with the processor, wherein the computer-readable storage medium comprises one or more programming instructions for: receiving a request for flight information; searching a plurality of Global Distribution System (GDS) databases or one or more airline databases directly in accordance with the request; and sending at least one result from the plurality of GDS databases corresponding to the request, the at least one result including at least one of an available flight upgrade or an available flight award.

The request for flight information includes at least one of a flight upgrade request or a flight award request. The at least one result includes the available upgrade or the available flight award.

In another exemplary embodiment, the one or more programming instructions further comprise sending the at least one result to the user via a web browser. Additionally, the one or more programming instructions further comprise providing the request for the flight information via a web browser. The one or more programming instructions further comprise displaying the at least one result on a display. The one or more programming instructions further comprise printing the at least one result via a printer.

The request for flight information includes at least one of a flight date, a flight date range, a flight time, a flight destination, a flight origination, a flight class, an upgrade class, an award class, and an airline.

The at least one result further includes at least one of an aircraft type, a frequency reliability, a description of an available flight upgrade, a description of an available flight reward, a number of seats for the available flight upgrade, and a number of seats for the available flight reward.

In yet another exemplary embodiment, the searching of the plurality of GDS databases is in response to an absence of the at least one available flight upgrade or the available flight award as specified by the request within a database. The absence of at least one of a flight date, a flight date range, a flight time, a flight destination, a flight origination, a flight class, an upgrade class, an award class, and an airline within the database initiates the searching of the plurality of GDS databases.

The one or more programming instructions further comprise: determining whether a database includes the at least one available flight upgrade or available flight award in accordance with the request; querying one of the plurality of GDS databases in response to an absence of the at least one flight upgrade or flight award; and storing a response from the queried GDS database in the database.

In yet another exemplary embodiment, the request for flight information includes a flight upgrade request corresponding to a plurality of destinations or a flight award request corresponding to the plurality of destinations, the at least one result including at least one of the available flight upgrades corresponding to the flight upgrade request or the available flight award corresponding to the flight award request.

The request for flight information includes a plurality of airline requests or a date range or a combination thereof. The request for flight information includes an airline, wherein at least one of the available flight upgrades corresponds to a partner airline of the airline or at least one of the available flight awards corresponds to the partner airline of the airline. The request for flight information and the searching of the plurality of GDS databases may be performed continuously and in real time.

In another exemplary embodiment, the request for flight information includes a request for an alert, the alert being a flight availability (may be award/upgrade/general availability) alert or a seat availability alert or a combination thereof, the alert taking place at predetermined time intervals.

Moreover, the at least one result corresponding to the request is based on multiple destination inputs. The at least one result corresponding to the request may also be based on multiple airline inputs. The user may be permitted to provide a range of dates pertaining to the flight information. The user may also be permitted to search for the available flight upgrades or the available flight awards on a plurality of airlines accepting accumulated miles.

A system is presented for querying travel-related data, including a processor and a non-transitory, computer-readable storage medium in communication with the processor, wherein the computer-readable storage medium comprises one or more programming instructions for: receiving a plurality of requests for alerts on a flight concerning (i) availability of a seat availability, (ii) availability of a flight upgrade, and (iii) availability of flight rewards; monitoring the alerts at predetermined time intervals by searching Global Distribution System (GDS) databases or one or more airline databases in accordance with the plurality of requests for alerts; and sending at least one result from the plurality of GDS databases corresponding to the plurality of requests for alerts.

After an alert is checked for a flight on a given flight date, the local database may checked to see what other users have created alerts for as to the same flight. Thus, the user may check for alerts created by other users for a same flight on the local database. As a number of alerts for the same flight increases, a cost per alert would decrease in the aggregate.

In another exemplary embodiment, the one or more programming instructions further comprise indicating in the plurality of requests for alerts that each respective departed flight need not be searched.

Moreover, the at least one result corresponding to the plurality of requests for alerts is based on multiple destination inputs. The at least one result corresponding to the plurality of requests for alerts is based on multiple airline inputs. The user may be permitted to provide a range of dates for an alert. The user may be permitted to conduct a non-flight specific search and receive an alert for any flight that satisfies one or more conditions for any type of the flight information.

In yet another exemplary embodiment, when a first result is submitted to the user, the user is permitted to re-submit at least one of a plurality of requests for alerts in order to receive a second result, the second result being different than the first result.

A method is presented for querying travel-related data, the method including receiving a request for flight information; searching a plurality of Global Distribution System (GDS) databases in accordance with the request; and sending at least one result from the plurality of GDS databases corresponding to the request, the at least one result including at least one of an available flight upgrade or an available flight award.

A method is presented for querying travel-related data, the method including receiving a plurality of requests for alerts on a flight concerning (i) availability of availability of seats, (ii) availability of a flight upgrade, and (iii) availability of further flight rewards; monitoring the alerts at predetermined time intervals by searching Global Distribution System (GDS) databases in accordance with the plurality of requests for alerts; and sending at least one result from the plurality of GDS databases corresponding to the plurality of requests for alerts.

### BRIEF DESCRIPTION OF THE DRAWINGS

These and other advantages will become more apparent from the following detailed description of the various embodiments of the present disclosure with reference to the drawings wherein:

FIG. 1 depicts a flowchart illustrating a method of providing frequent flyer award and upgrade availability to a user, in accordance with the present disclosure;

FIG. 2 depicts a flowchart illustrating a method of providing flight alerts and seat alerts to the user, in accordance with the present disclosure;

FIG. 3 illustrates a screen of a web page for allowing the user to enter flight search criteria, in accordance with the present disclosure;

FIG. 4 illustrates a screen of a web page for returning a plurality of results related to the flight search criteria entered in the screen of FIG. 3, in accordance with the present disclosure;

FIG. 5 illustrates an admin screen for displaying alert type mappings, in accordance with the present disclosure;

FIG. 6 illustrates an admin screen for displaying alert type algorithms, in accordance with the present disclosure;

FIG. 7 depicts a detailed flowchart illustrating a method of providing frequent flyer award and upgrade availability to the user, in accordance with the present disclosure;

FIG. 8 depicts a detailed flowchart illustrating a method of monitoring flight alerts and seat alerts to the user, in accordance with the present disclosure; and

FIG. 9 depicts a detailed flowchart illustrating a method of processing flight alerts and seat alerts to the user, in accordance with the present disclosure.

The figures depict preferred embodiments of the present disclosure for purposes of illustration only. One skilled in the art will readily recognize from the following discussion that alternative embodiments of the structures and methods illustrated herein may be employed without departing from the principles of the present disclosure described herein.

### DETAILED DESCRIPTION

Particular embodiments of the present disclosure are described herein below with reference to the accompanying drawings. In the following description, well-known functions or constructions are not described in detail to avoid obscuring the present disclosure in unnecessary detail.

Various modifications to the preferred embodiment, disclosed herein, will be readily apparent to those of ordinary skill in the art and the disclosure set forth herein may be applicable to other embodiments and applications without departing from the spirit and scope of the present specification and the claims hereto appended. Thus, the present specification is not intended to be limited to the embodiments described, but is to be accorded the broadest scope consistent with the disclosure set forth herein.

The present disclosure is described below with reference to block diagrams and/or flowchart illustrations of methods, apparatus (systems and/or devices) and/or computer program products according to embodiments of the disclosure. It is understood that a block of the block diagrams and/or flowchart illustrations, and combinations of blocks in the block diagrams and/or flowchart illustrations, may be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

The exemplary embodiments of the present disclosure propose a framework of systems and methods that allow businesses to determine their customers' preferences (implicitly or explicitly, in advance or in quasi-real-time) for flexibility in purchasing products and/or inventory and to dynamically integrate these preferences with internal company operations to concurrently maximize value for both customers (individually or as a group or purchase utilities) and the company (i.e., its profitability).

Prior to describing the present disclosure in further detail, it will first be helpful to define various terms that will be used throughout the following discussion. For example:

The term “entity” includes “entity” or “entities” and all of those terms will include individual(s), group of individuals, company, companies, sole proprietorships, partnerships, corporations or any other legal entity or combination or consortium thereof.

The term “airline” or “airlines” includes, but is not limited to, an airline, an airline's business partner, an entity which deals with an airline or an airline's business partner, a travel agent, an online travel agent, an option aggregator, any entity forming a part of the chain of commerce related to airline and/or travel industry, or any combination of any two or more of the above.

The term “product” refers to a product or service provided by a manufacturer or a provider. For example, in the airline industry, a flight seat is a product that the airline sells to its customers. The term “product” may be used interchangeably with the term “inventory.”

The term “customer” implies an entity buying or entering into a contract to buy a company's product or service. The term “customer” may also refer to a passenger or any entity buying or entering into a contract to buy an airline's product or service or inventory. The term “customer” may be equivalent to the terms “user” and/or “subscriber.”

The term “flight” refers to a single flight, a group of flights, flights with zero or more stops or any combination of the above. The term “Itinerary” refers to a list of flights included in a single travel trip of a customer. An Itinerary may consist of one or more “Segments” (defined below). An Itinerary may be a one-way trip (one Segment), a round-trip (two Segments) or a multi-city trip (two or more Segments). A round-trip Itinerary has two Segments back and forth between two places. Consider a trip from A to B and then back from B to A. This is an example of a round-trip Itinerary. A One-Way Itinerary has only one Segment (such as travel from A to B). A Multi-City Itinerary refers to an Itinerary with two or more Segments between two or more places.

The term “Flight Segment” (or “Segment”, in short) refers to a part of an itinerary between a customer's intended origin and destination. A Segment may consist of one or more “Flight Legs.” The term “Flight Leg” (or “Leg”, in short) is the most fundamental unit of an Itinerary and is defined by a single takeoff and landing of a flight. In a round-trip Itinerary (A to B and B to A), there may be 2 Flight Legs from A to B (customer flies from A to C and then C to B, two connecting flights), and similarly two Flight Legs from B to A (customer flies from B to D and then D to A, two connecting flights).

The term “transaction” here implies to do, to carry or to conduct an agreement or exchange. The exchange may or may not involve a price in terms of monetary value from customer side. The parties participating in the transaction may have obligation(s) from various terms and conditions. In other words, transaction may also imply an action or activity involving two parties or things that reciprocally affect or influence each other. A transaction is an agreement between the customer and the airline for exchange of any goods or services or products or inventories.

The term “payment” here implies the act of paying or the state of being paid. The term “payment” here implies an amount of money or any other consideration paid at a given time or which has been received in the past but for which the benefit of the same is realized now, may be in part or in totality. “Payment” may also refer to a transfer of something of value to compensate for goods or services that have been, or will be, received. Payment may be made in cash, on credit or by transfer of miles or any other consideration. The payment may be from company to customer or from customer to company or both.

The term “storage” may refer to at least data storage. “Data storage” may at least refer to any article or material (e.g., a hard disk) from which information is capable of being reproduced, with or without the aid of any other article or device. “Data storage” may at least refer to the holding of data in an electromagnetic form for access by a computer processor. Primary storage is data in random access memory (RAM) and other “built-in” devices. Secondary storage is data on hard disk, tapes, and other external devices. “Data storage” may also at least refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “application” in the disclosed embodiments refers to at least a program designed for end users of a computing device, such as a word processing program, a database program, a browser program, a spreadsheet program, a gaming program, and the like. An application is distinct from systems programs, which consist of low-level programs that interact with the computing device at a very basic level, such as an operating system program, a compiler program, a debugger program, programs for managing computer resources, and the like.

The term “processing” may at least refer to determining the elements or essential features or functions or processes of one or more electronic devices or mobile devices for computational processing. The term “processing” may further refer to tracking data and/or collecting data and/or manipulating data and/or examining data and/or updating data on a real-time basis in an automatic manner and/or a selective manner and/or manual manner (continuously, periodically or intermittently).

The term “electronic device” may at least refer to one or more personal computers (PCs), a standalone printer, a standalone scanner, a mobile phone, an MP3 player, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics may apply in any type of entertainment, communications, home, and/or office capacity. Thus, the term “electronic device” may at least refer to any type of electronics suitable for use with a circuit board and intended to be used by a plurality of individuals for a variety of purposes.

Additionally, “electronic devices” may refer to at least, or may include but are not limited to, a mouse, keyboard, Bluetooth™ adapter, global positioning system (GPS) receiver, remote control, audio module, user interface module, electronic-book reader module, radio frequency identification (RFID) reader, barcode reader, digital projector, universal serial bus stick, magnetometer, and fingerprint reader. Moreover, “electronic devices” may refer to at least, or may include but are not limited to, an electronic book, displays, television sets, electronic paper, watches, electronic calculators, cellular phones, personal digital assistants, view finder, direct view type video tape recorder, car navigation system, pager, electric calculator, word processor, work station, picture telephone, point of sale (POS) terminal(s), point-of-entry (POE) terminal(s) and any type of electrical or mechanical or electromechanical apparatus/system/configuration with one or more touch panels.

Within this disclosure, the term “user” may also include, in addition to human users: computers, automated systems, controllers, robotic devices, and other electro-mechanical devices, systems, configurations/apparatuses using software (or code).

Embodiments will be described below while referencing the accompanying figures. The accompanying figures are merely examples and are not intended to limit the scope of the present disclosure.

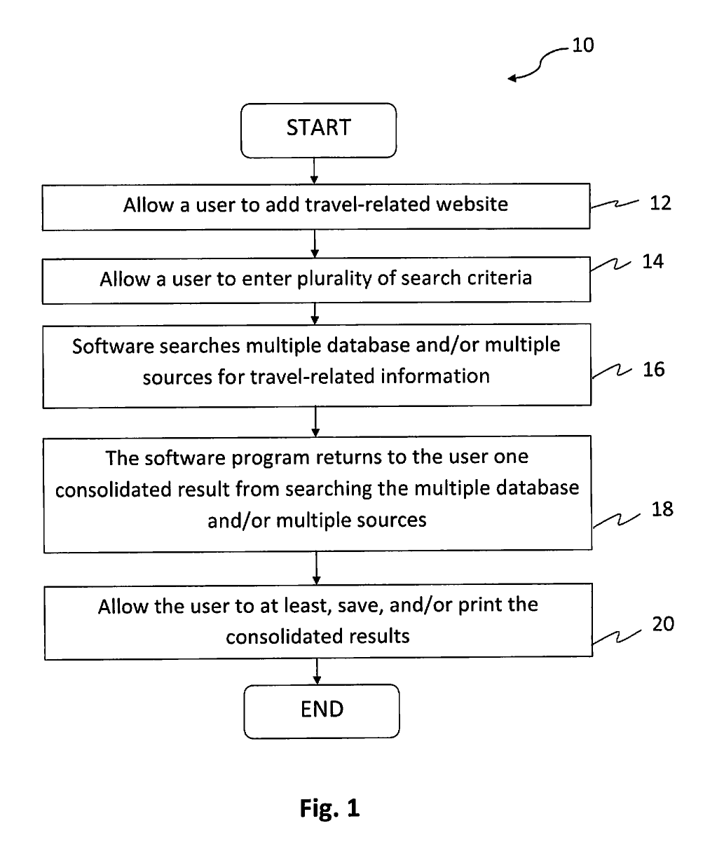

Referring to FIG. 1, a flowchart illustrating a method of providing frequent flyer award and upgrade availability to the user, in accordance with the present disclosure is presented.

The flowchart 10 includes the following steps. In step 12, the user is permitted to access a travel-related website. In step 14, the user is permitted to enter a plurality of search criteria. In step 16, software searches multiple databases and/or multiple sources for travel-related information. In step 18, the software returns to the user one consolidated result based on the searching of the multiple databases and/or multiple sources. In step 20, the user is permitted to at least view, save, and/or print the consolidated results returned. The process then ends for the first cycle or first iteration. However, the process may be a continuous iterative process. In other words, the steps of the process may repeat for a number cycles or iterations, where at least the communicating, receiving, searching, and sending steps are constantly and continuously repeated.

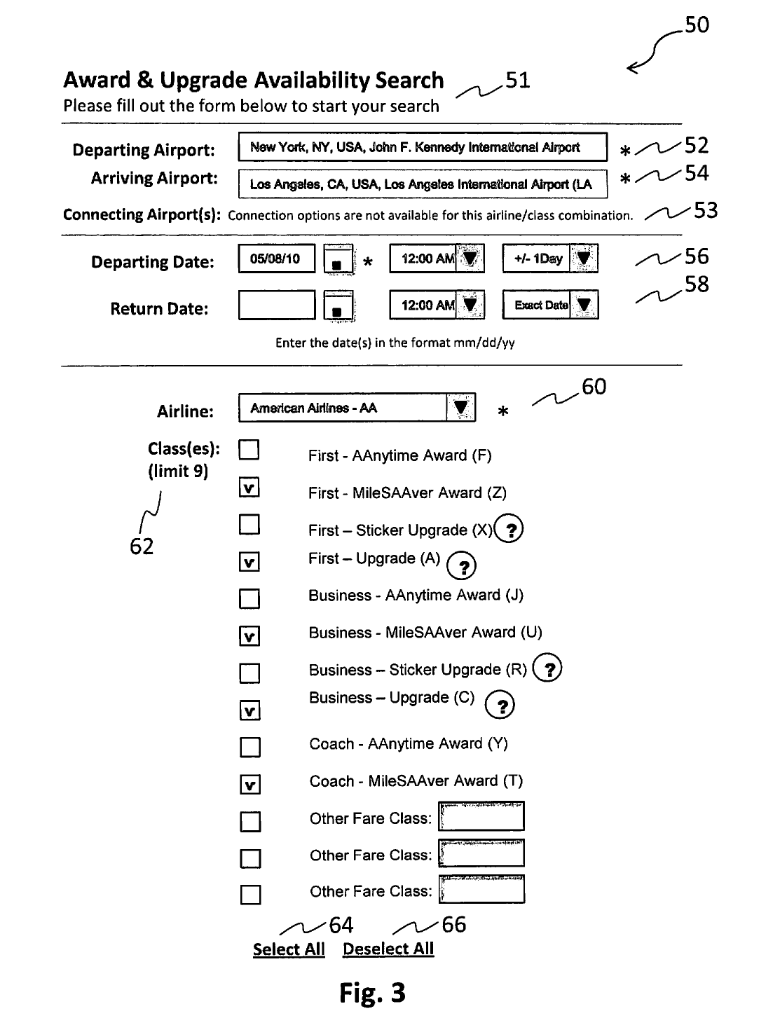

Therefore, FIG. 1 relates to a method that allows for searching for multiple pieces of airline data/information, such as frequent flyer award and upgrade availability, and combining such airline data/information received from multiple sources into one consolidated result, based on search criteria received from users/subscribers via at least one web page (see FIG. 3 below). The award and upgrade search allows users to request multiple awards and/or upgrade class inventories, as well as from multiple time periods. The inventories may be representations of availability of awards and upgrades for a particular flight.

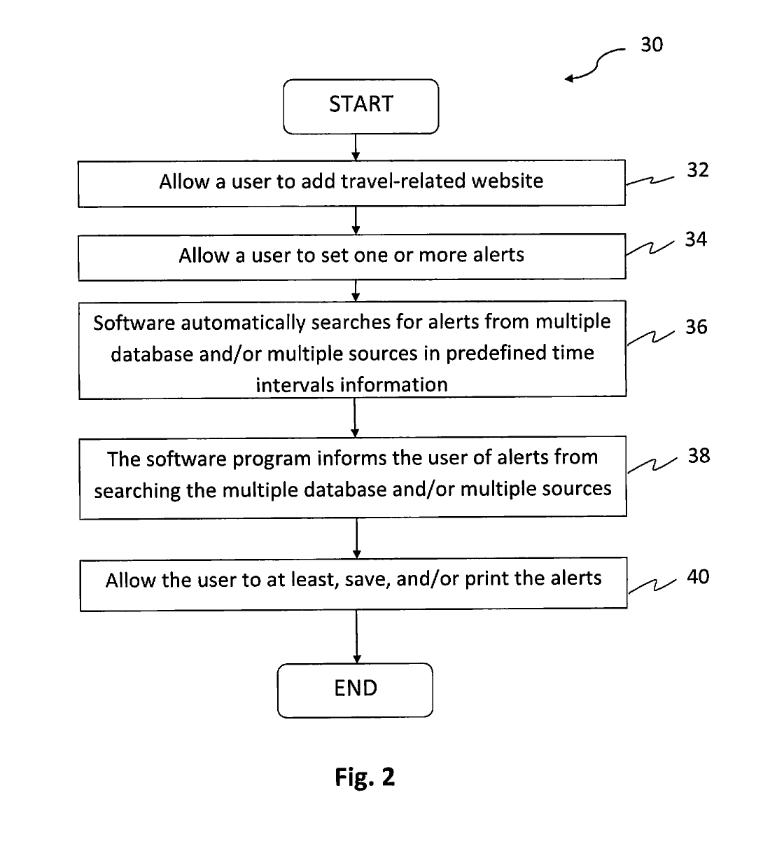

Referring to FIG. 2, a flowchart illustrating a method of providing flight alerts and seat alerts to the user, in accordance with the present disclosure is presented.

The flowchart 30 includes the following steps. In step 32, the user is permitted to access a travel-related website. In step 34, the user is permitted to set one or more alerts. In step 36, software searches for alerts to check from multiple databases and/or multiple sources in predefined time intervals. In step 38, the software informs the user of alerts based on the searching of the multiple databases and/or multiple sources. In step 40, the user is permitted to at least view, save, and/or print the alerts returned. The process then ends for the first cycle or first iteration. However, the process may be a continuous iterative process. In other words, the steps of the process may repeat for a number cycles or iterations, where at least the communicating, receiving, searching, informing, and sending steps are constantly and continuously repeated.

Therefore, FIG. 2 relates to flight and seat alert methods allowing users/subscribers to set one or more alerts, in which the system checks for either a specific airline class inventory (e.g., a flight alert) or specific seat availability on a given flight (e.g., a seat alert) on scheduled intervals on the users' behalf without requiring user interaction to do so (i.e., automatically).

The system running the methods described in FIGS. 1 and 2 is preferably operated by a company or entity that provides electronic distribution of travel information to travel agencies, travel providers, and other corporations/entities

The subscribers/users may be Internet web sites that provide flight availability data to a plurality of clients in exchange for a payment. Each subscriber may operate one or more requesting servers and each requesting server may be customized for each subscriber. Each client preferably operates one of a plurality of personal computers and communicates with one of the requesting servers through a network, such as, the Internet. The network may be operated by the subscribers or a third party network connectivity supplier. For example, one of the clients may use his/her personal computer (PC) to access one of the requesting servers operated by one of the subscribers through the network. The client may use the requesting server to plan a trip and access flight availability data supplied by one or more of the airline servers through the system. Alternatively, the subscribers may be individual travel agents or travel agencies. Additionally, the requesting servers may be simple terminals connected directly to the system or may be complex terminals provided in remote locations.

The requesting servers send the availability request to the system. The availability request typically includes a subscriber identification (SID) identifying the subscriber originating the availability request, an origin, and a destination. Additionally, the availability request may include a return trip which would start at the destination and finish at the origin. Furthermore, the availability request may specifically involve stops at locations other than the origin and the destination, include an airline carrier code (CC) identifying a specific airline, and/or specify certain dates and times for which to search.

The system receives the availability request and, if necessary, may send the real-time request to the airline servers. The real-time request sent from the system may account for factors, such as minimum connection times between flights, regulatory display parameters, and other criteria. The request for flight information may include at least one of a flight date, a flight date range, a flight time, a flight destination, a flight origination, a flight class, an upgrade class, an award class, and an airline. The at least one result may further include at least one of an aircraft type, frequency, reliability, a description of an available flight upgrade, a description of an available flight reward, a number of seats for the available flight upgrade, and a number of seats for the available flight reward. These processes including such flight information and requests will be described in detail below with reference to FIGS. 3-9.

Referring to FIG. 3, a screen of a web page for allowing the user to enter flight search criteria, in accordance with the present disclosure is presented.

The screen 50 includes a plurality of search criteria to be entered by the user. The screen 50 is designated as an “Award & Upgrade Availability Search” form 51. The search criteria may include, but is not limited to, a departing airport entry 52, an arriving airport entry 54, a connecting airport entry 53, a departure date entry 56, a return date entry 58, an airline entry 60, and a classes entry 62. The user may be permitted to select a “Select All” button 64 or a “Deselect All” button 66. Of course, one skilled in the art may contemplate providing the user with a plurality of different buttons and/or a plurality of different entries in order to extract the appropriate information from the user.

It is noted that the connecting airport entry 53 is a powerful option available to the user because by specifying, for example, one or two airports in such category, the query only searches for flights that connect through the airport(s) specified. This allows the user to see flights that only connect through one specific airport, which may be desirable for weather related or logistical reasons or to plan mileage runs. Additionally, the classes entry 62 allows the user to select up to 9 classes. The classes may be any combination of award and upgrade classes by using the check box selection. However, classes may also be manually entered by the user based on preference (e.g., award, upgrade, revenue, etc.). One skilled in the art may contemplate allowing the user to enter a number of classes greater than 9.

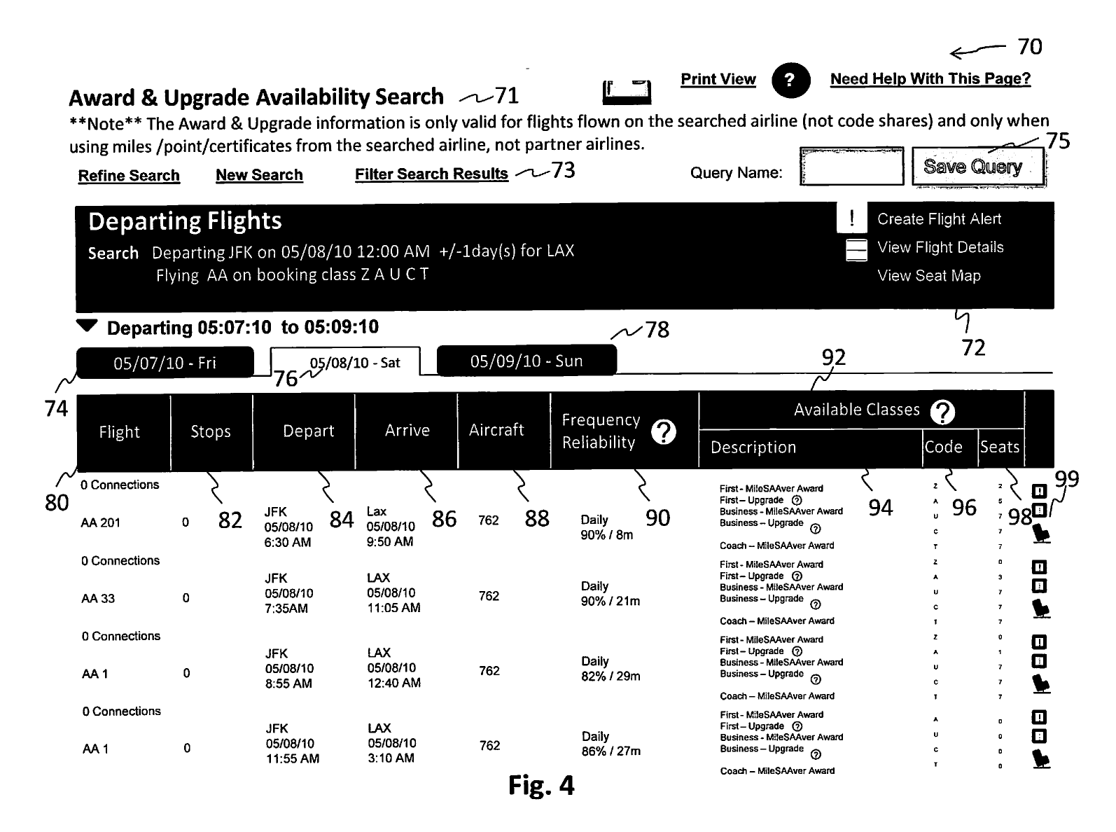

Referring to FIG. 4, a screen of a web page for returning a plurality of results related to the flight search criteria entered in the screen of FIG. 3, in accordance with the present disclosure is presented.

The screen 70 includes a plurality of results returned based on the search criteria entered by the user in screen 50. The screen 70 is designated as “Award & Upgrade Availability Results” 71. The top portion of the screen 70 may include links 73 for allowing the user to refine a search, to conduct a new search, to further filter the search results. Additionally, a “Save Query” button 75 may be provided for allowing the user to save the plurality of results returned. Throughout various query response screens, the user is given the option to save the query by entering in a name and clicking on the “Save Query” button 75. This action saves the query in the appropriate query category. These queries may be recalled from a side panel using a drop down lists section in a “Saved Queries” section.

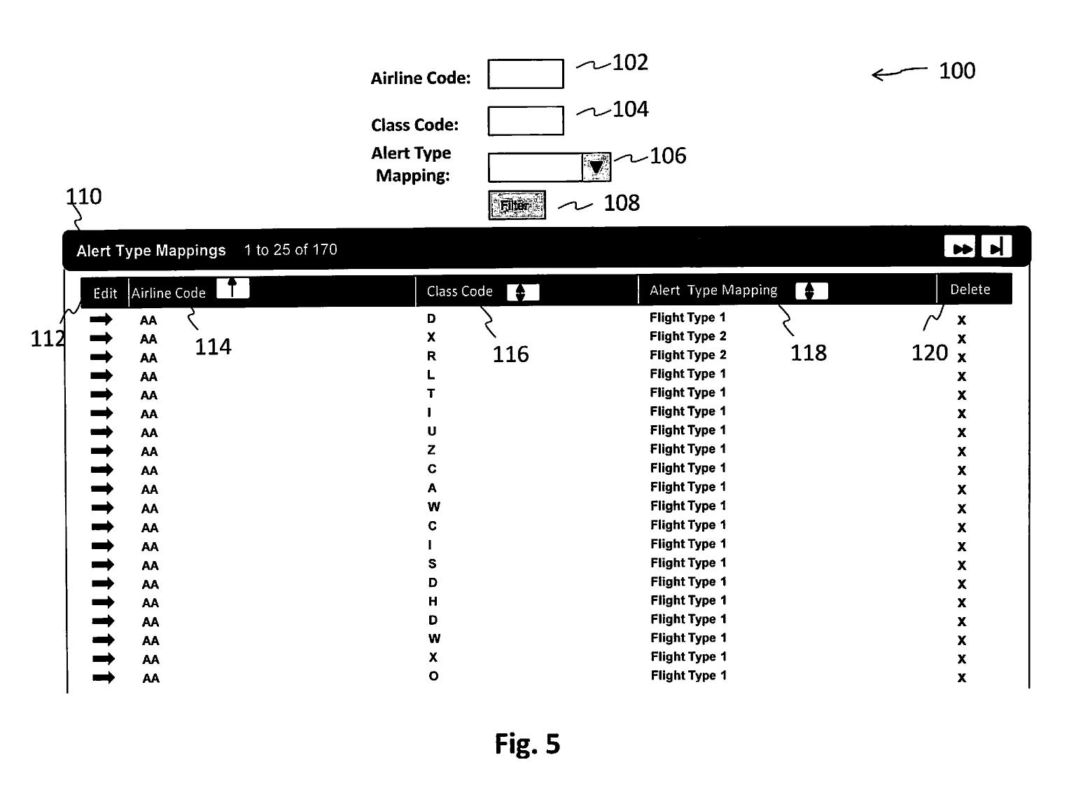

It is noted that the links 73 include a filter link for use by the user. The filter itself may be set by an admin, as shown in FIG. 5 described below. For example, regarding the “Filter” button 108, the button 108 allows the admin to show or hide specific class codes for the flights shown on the admin screen 100 (see FIG. 5). In addition, a “Show Flights with No Availability” option may allow the admin to hide flights that have no availability at all in the selected classes. By having the admin un-checking this option, the user only sees flights that have a “seats value” of 1 or greater in the selected classes.

In such exemplary embodiment of FIG. 4, the user searches for departing flights 72. Specifically, the user wishes to find a departing flight from JFK airport in New York to LAX airport in Los Angeles. The date of departure is May 8, 2010. Of course, the user is permitted to search several dates of departure and view such results on the screen 70. For example, a first tab 74 may incorporate the search results of May 7, 2010. A second tab 76 may incorporate the search results of May 8, 2010, whereas a third tab 78 may incorporate the search results of May 9, 2010. As such, the user may click on a desired tab in order to access and compare search results for different days of departure. Of course a number of tabs may be provided.

The results may be organized and categorized into a plurality of data columns. For example, the following data columns may be presented to the user: a flight data column 80, a stops data column 82, a depart data column 84, an arrive data column 86, an aircraft data column 88, frequency and reliability data column 90, and a class availability data column 92. The class availability data column 92 may be further categorized into several more data columns. For instance, the class availability data column 92 may include a description column 94, a code column 96, and an available seats data column 98. Additionally, the list of results may include icons 99 representing additional information. For example, the (!) icon allows the user to create an alert for the flight, the 2^{nd} icon allows users to get the details of a flight, and the seat icon allows users to view the seat map for the flight. Of course, one skilled in the art may contemplate providing the user with a plurality of different buttons and/or a plurality of different entries in order to extract the appropriate information from the user. One skilled in the art may contemplate organizing the data/information in a plurality of different configurations suitable for display on a web page or any other electronic device, as defined herein, for receiving such data/information.

Referring to FIG. 5, an admin screen for displaying alert type mappings, in accordance with the present disclosure is presented.

The admin screen 100 includes data/information related to alert type mappings. The admin screen 100 may include an airline code entry 102, a class code entry 104, and an alert type mapping entry 106. The admin screen 100 may also include a “Filter” button 108 for filtering results presented to the user (as described above with reference to FIG. 4). Additionally, the admin screen 100 may have an alert type mapping dialog box 110. The alert type mapping dialog box 110 may include a plurality of data columns, such as an edit data column 112, an airline code data column 114, a class code data column 116, an alert type mapping data column 118, and a delete data column 120. One skilled in the art may contemplate organizing the data/information in a plurality of different configurations suitable for display on a web page or any other electronic device, as defined herein, for receiving such data/information.

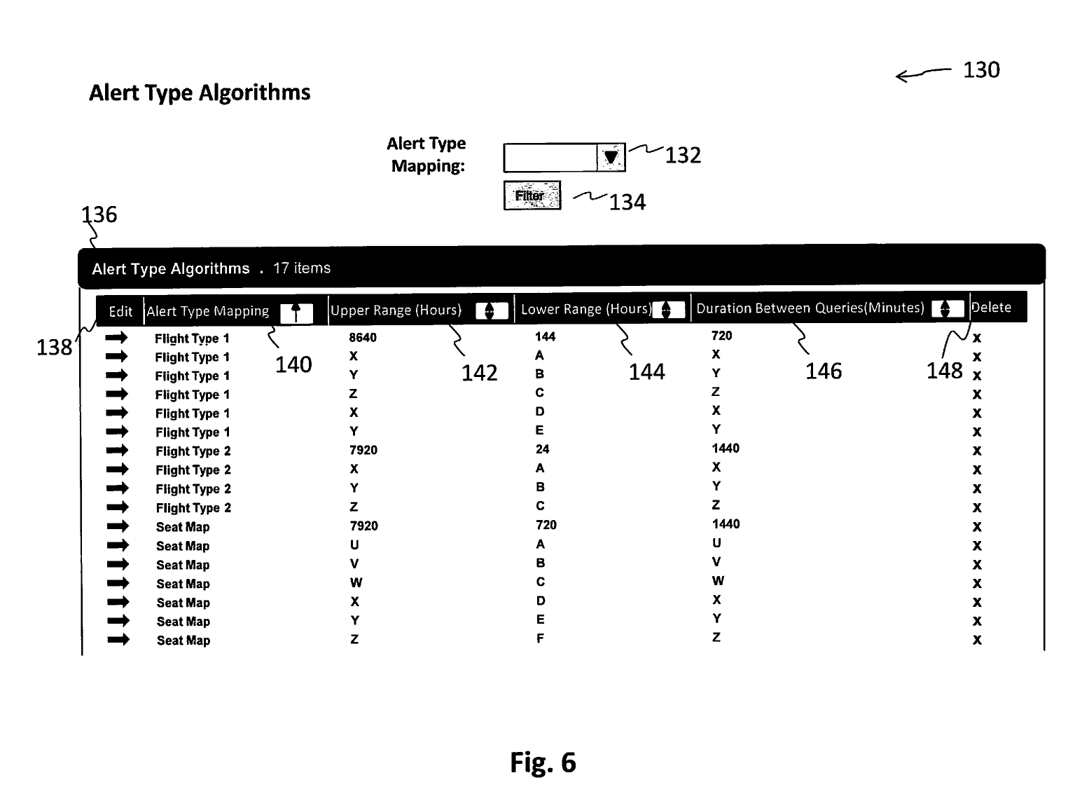

Referring to FIG. 6, an admin screen for displaying alert type algorithms, in accordance with the present disclosure is presented.

The admin screen 130 includes data/information related to alert type algorithms. The admin screen 130 may include an alert type mapping entry 132 and a “Filter” button 134. Additionally, the admin screen 130 may include an alert type algorithm dialog box 136. The alert type algorithm dialog box 136 may include a plurality of data columns, such as an edit data column 138, an alert type mapping data column 140, an upper range (hours) data column 142, a lower range (hours) data column 144, a duration between queries data column 146, and a delete data column 148. Therefore, the admin may use admin screen 130 to adjust the schedule of when alerts are checked. One skilled in the art may contemplate organizing the data/information in a plurality of different configurations suitable for display on a web page or any other electronic device, as defined herein, for receiving such data/information.

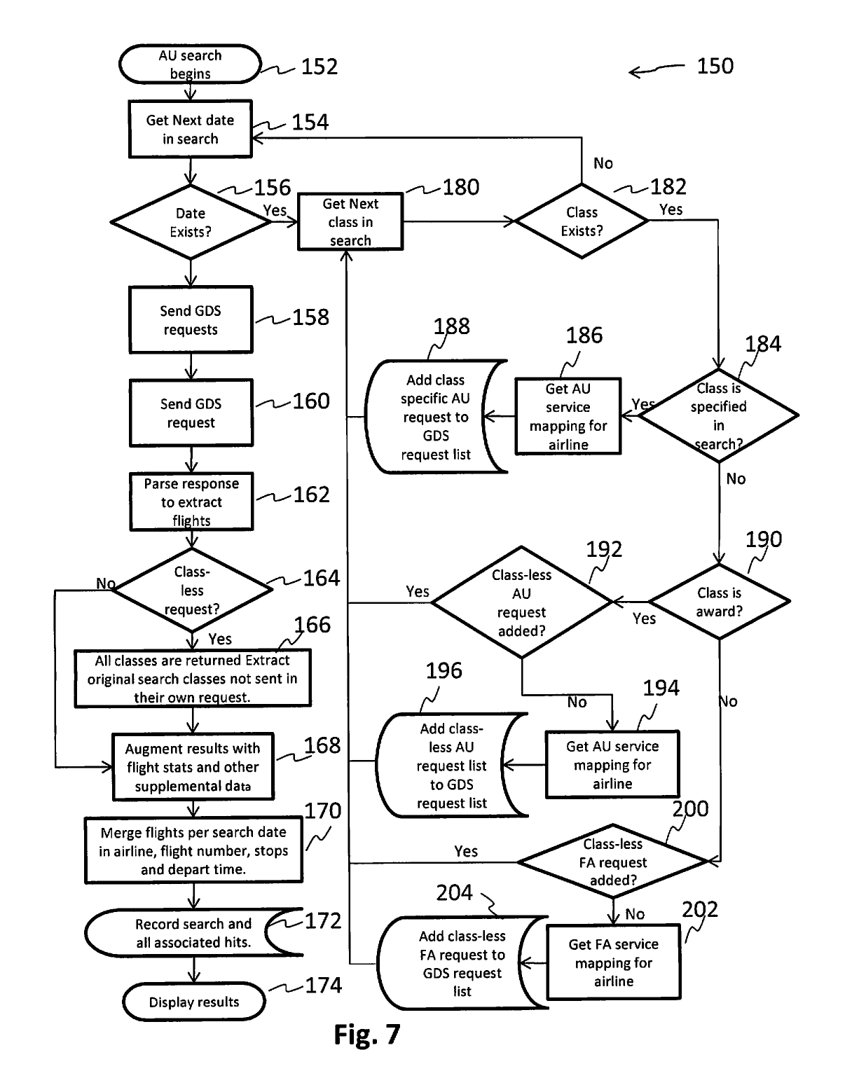

Referring to FIG. 7, a detailed flowchart illustrating a method of providing frequent flyer award and upgrade availability to the user, in accordance with the present disclosure is presented.

The flowchart 150 includes the following steps. In step 152, a search for awards and upgrades commences. In step 154, a next date in the search is obtained. In step 156, a question is posed as to whether the data exists. If the next date does exist, the process flows to step 180, which will be described below. If the next date does not exist, then the process flows to step 158. In step 158, Global Distribution System (GDS) requests are sent. The GDS acts as a distributor or airline and other travel information between the source (e.g., the airline) and the user. Additional services offered by the GDS may include, but are not limited to, booking and ticketing capabilities. In step 160, an individual GDS request is sent. The individual GDS request submitted to the thread pool is executed according to the thread pool implementation. If the thread pool is at capacity, the GDS request is queued (FIFO) until an opening is available.

In step 162, the response is parsed to extract the flights. In step 164, a question is posed as to whether the response falls within a predefined class. If the answer is “NO” the process flows to step 168. If the answer is “YES” the process flows to step 166. In step 166, all the classes are returned and original search classes not sent on their own request are extracted. In step 168, the results are augmented with flight statistics and other supplemental information. In step 170, the flights are merged (from the multiple individual GDS requests of step 160). For example, the flights per search date on airline, flight numbers, stops, and departure times are merged. In step 172, the search and all the associated hits are recorded or saved, either locally or remotely in a data storage or memory, as defined herein. In step 174, the results are displayed to the user on a display means of electronic devices, as defined herein.

Referring back to step 156, if the next date does exist, the process flows to step 180. In step 180, a new class is obtained in the search. In step 182, a question is posed as to whether the class exists. If the class does not exist, the process flows back to step 156. However, if the class does exist, the process flows to step 184. In step 184, a question is posed as to whether the class is to be specified in the search. If “YES,” the process flows to step 186. If “NO,” the process flows to step 190. In step 186, the awards and upgrade service mapping for the airline is obtained. In step 188, the class-specific awards and upgrade request is added to the GDS request list. The process then flows to step 180. Regarding steps 186 and 188, the information about this class is only provided if specifically requested, such that this class is present in the request parameters. The request is handled by the designated award and upgrade service host (i.e., GDS). Furthermore, referring back to step 184, if the class is not specified in the search, the process flows to step 190 where another question is posed.

In step 190, a determination is made as to whether the class is an award class. If the answer is “YES,” the process flows to step 192. If the answer is “NO,” the process flows to step 200. If “YES,” in step 192 it is determined whether the awards and upgrades request pertaining to the class has been added. If so, the process flows to step 180. If not, the process flows to step 194. In step 194, the awards and upgrades service mapping for the airline is obtained. In step 196, the awards and upgrades request is added to the GDS request list. The process then flows to step 180. Regarding steps 192, 194, 196, the information about this class is provided in a general search, such that this class is not present in the request parameters. Consolidating all such classes into a single class-less request makes efficient use of the service host (e.g., GDS). Being an award class, the request is handled by the designated award and upgrade service host or GDS.

However, in step 190, if the class is not an award class, the process flows to step 200. In step 200, it is determined whether a general flight availability request pertaining to a non-award/upgrade class has already been added to the list of GDS requests for the search. If the answer is “YES,” the process flows to step 180. If the answer is “NO,” the process flows to step 202, where the flight availability service mapping the airline is obtained. In step 204, the flight availability request pertaining to a non-award/upgrade class is added to the GDS list. The process then flows to step 180. Regarding steps 200, 202, 204, information about this class is provided in a general search, such that this class is not present in the request parameters. Consolidating all such classes into a single class-less request makes efficient use of the service host or GDS. Being a non-award class, the request is handled by the designated flight availability service host or GDS. The process then ends for the first cycle or first iteration. However, the process may be a continuous iterative process. In other words, the steps of the process may repeat for a number cycles or iterations, where at least the communicating, receiving, searching, parsing, extracting, augmenting, merging, and sending steps are constantly and continuously repeated.

Therefore, regarding FIG. 7, in one exemplary embodiment, the system first iterates through all the dates in the search and for each date in the search, the system iterates through all the classes requested. For each class, the system determines the proper way to get the data for that class, deciding: (1) if the class is designated in the system as having to be specified in the search, the system looks up the host to get the data for that class from, then adds the request to the list of requests for that user search or (2) if not, the data source for that class based on the airline, and if its an award or upgrade class or a non-award and non-upgrade (regular) class code.

Thus, there is one award and upgrade request generated for that airline (if need be) and one regular flight availability request generated for the airline (if need be) from the remaining list of class codes for the search for that day. Alternatively, requests that specify the class in the request are each separate, so that one regular availability search, one non-class specific AU search, and multiple class specific AU searches are required. Once all the necessary host or Global Distribution Systems (GDS) requests are determined for all class codes for all days, the host requests are made. For each day, the results of the various classes that are searched are merged into one unified result set for every day searched. The search results are then outputted, for example, via display means or printed out via a printer, for review by the users/subscribers (see FIG. 4 above). It is also contemplated that the users/subscribers pay a fee (e.g., a monthly fee) to the entity in charge of the travel-data related website or other entity controlling/operating such site.

Alternatively, concerning the awards and upgrades methodologies of FIG. 7, the user may be able to enter multiple destinations for a search. For example, an award or upgrade may be provided to the user regarding flights from NYC to LAX or SFO or DTW, etc. In other words, multiple destination locations may be entered into the search criteria.

Alternatively, concerning the awards and upgrades methodologies of FIG. 7, the user may be able to enter multiple airlines for a search. For example, an award or upgrade may be provided to the user regarding Delta Airlines, JetBlue, and U.S. Airways regarding a specific destination.

Alternatively, concerning the awards and upgrades methodologies of FIG. 7, the user may be able to enter a range of dates for a search. For example, award or upgrade information for a flight that satisfies at least one condition for any given date range may be provided to the user.

Alternatively, concerning the awards and upgrades methodologies of FIG. 7, the user may be able to search for rewards and upgrades not only offered on a single airline, but rewards and upgrades offered on a plurality of airlines, where the mileage accruals are compatible (airline alliances). Thus, the user is permitted to search for the available flight upgrades or the available flight awards on a plurality of airlines accepting accumulated miles.

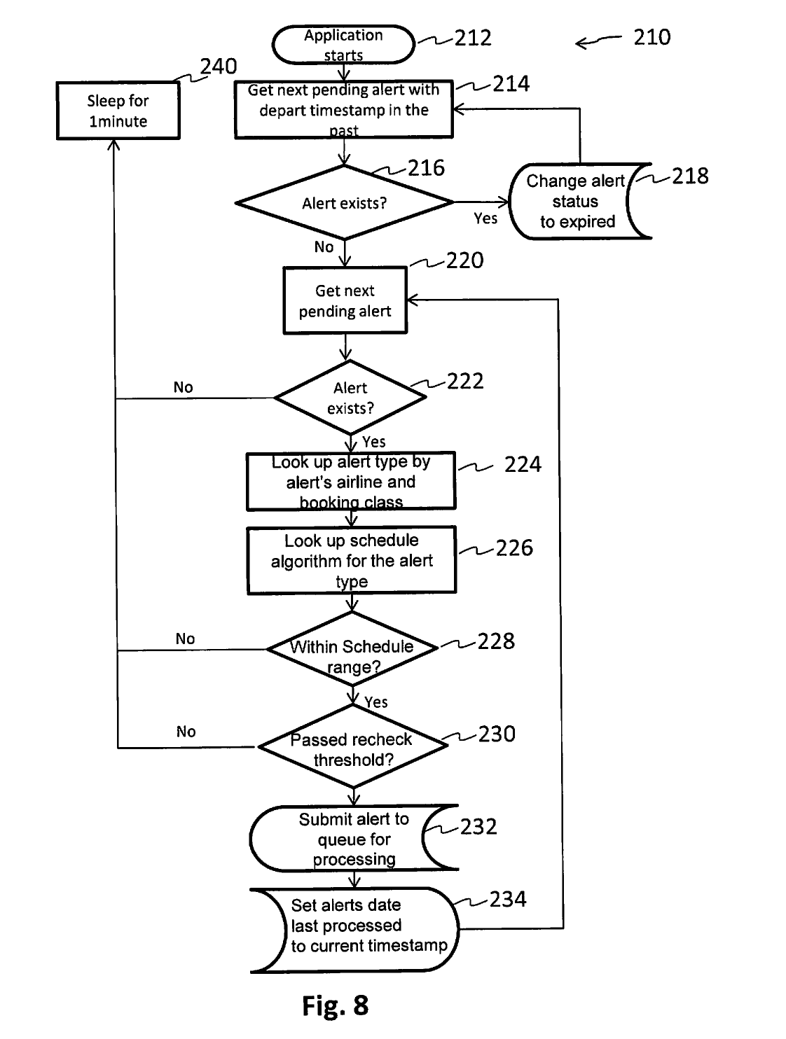

Referring to FIG. 8, a detailed flowchart illustrating a method of monitoring flight alerts and seat alerts to the user, in accordance with the present disclosure is presented.

The flowchart 210 includes the following steps. In step 212, the application commences. In step 214, the next pending alert (with a depart time stamp in the past) is obtained. In step 216, it is determined whether such an alert exists (with a depart timestamp in the past). If the answer is “YES,” the process flows to step 218, where the alert status is changed to “expired.” If the answer is “NO,” the process flows to step 220, where the next Pending alert is obtained. In step 222, the question is posed as to whether such an alert exists. If “NO,” the process flows to step 240, where the process stops or pauses for a minute (or any other predetermined time). If the answer is “YES,” the process flows to step 224 where the alert type is looked up by the alert's airline and the booking class. In step 226, the schedule algorithm for the alert type is looked up.

Regarding steps 224, 226, alert types are associated with dynamic scheduling algorithms, which define when an alert should run based on duration of departure time and duration since the last check alert. For example, referring back to FIG. 6, for a flight X number of hours out, the alert recheck threshold may be Y number of minutes. Of course, one skilled in the art may contemplate using a plurality of different timing scenarios and/or configurations for various flights and/or requests and/or inventories and/or products. Therefore, the hours range and the minimum duration values may be changed as one skilled in the art sees fit.

In step 228, it is determined whether the alert type is within the schedule range. For example, does the departure date in the alert criteria fall within a range of any existing algorithm entries (e.g., within 144-480 hours out)? If the answer is “NO,” the process flows to step 240 where the process pauses for 1 minute. If the answer is “YES,” the process flows to step 230 where it is determined whether the alert type passed a recheck threshold. For example, for the schedule record identified above, has the recheck threshold been reached (e.g., 360 minutes since the last check)? If the answer is “NO,” the process flows to step 240 where the process pauses for 1 minute. If the answer is “YES,” the process flows to step 232. In step 232, the alert is submitted to the queue for processing. In step 234, the last processed date stamp is set to the current time stamp. The process then flows back to step 220. The process then ends for the first cycle or first iteration. However, the process may be a continuous iterative process. In other words, the steps of the process may repeat for a number cycles or iterations, where at least the communicating, receiving, searching, processing, and sending steps are constantly and continuously repeated.

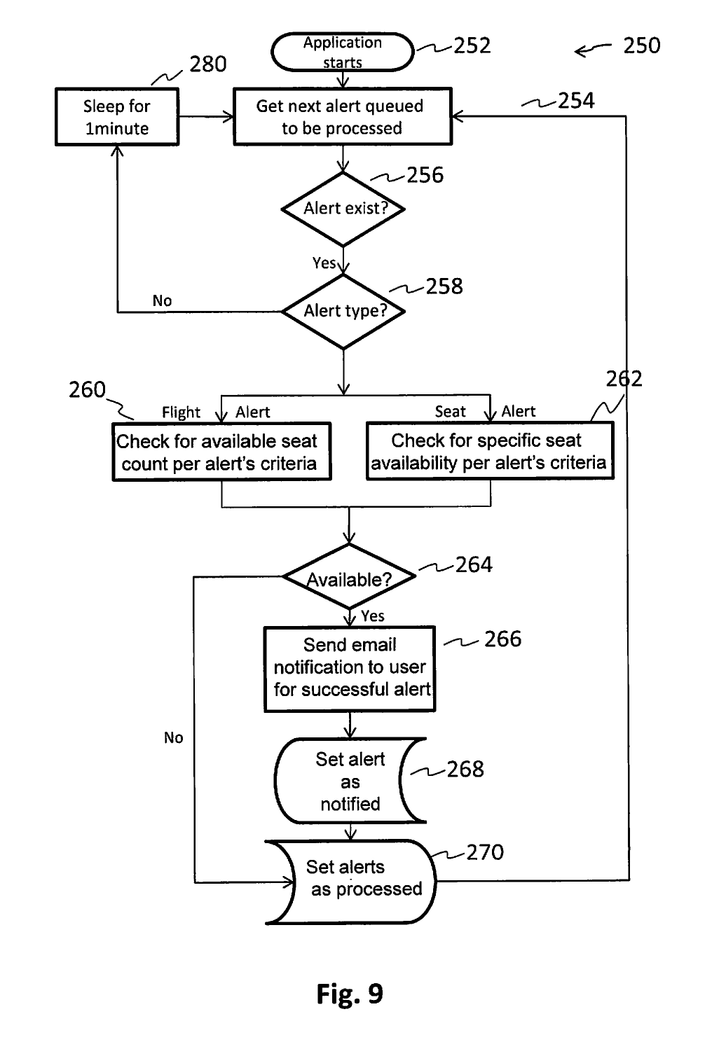

Therefore, regarding FIG. 8, in one exemplary embodiment, the alert system may include an alert monitoring means. The alert monitor checks the system database at a specified interval to determine if any alerts are scheduled to be checked that are due. First, the alert monitor determines if there are any pending alerts in the system for flights that have already departed. If so, it marks them as expired. Then the alert monitor determines if a pending alert needs to be checked. It does so by determining the alert type and then the schedule for that alert type and comparing the date the alert was last checked to the current time and the schedule for that alert type. If the alert is within range of a defined schedule, and past the recheck threshold, it is added to the alert queue for processing by the alert processor (see FIG. 9 below), and its last processed date stamp is updated. This process is repeated for all pending alerts for each run of the alert monitor.

Referring to FIG. 9, a detailed flowchart illustrating a method of processing flight alerts and seat alerts to the user, in accordance with the present disclosure is presented.

The flowchart 250 includes the following steps. In step 252, the application commences. In step 254, the next alert queued to be processed is obtained. In step 256, it is determined whether the next alert exists. If the answer is “NO,” the process flows to step 280 where the process pauses for 1 minute. If the answer is “YES,” the process flows to step 258, where the alert type is determined. If the alert is a flight alert, in step 260, a check is made for available seat count per alert's criteria. If the alert is a seat alert, in step 262, a check is made for specific seat availability per alert's criteria.

In step 264, availability is determined. If there is no availability, the process flows to step 270, where the alert is set as “processed.” If there is availability, the process flows to step 266, where an email notification is sent to the user indicating a successful alert. In step 268, an alert is set as “notified.” The process then flows to step 270, where the alert is set as “processed.” The process then loops back to step 254. The process then ends for the first cycle or first iteration. However, the process may be a continuous iterative process. In other words, the steps of the process may repeat for a number cycles or iterations, where at least the communicating, receiving, searching, checking, notifying, processing, and sending steps are constantly and continuously repeated.

Therefore, regarding FIG. 9, in one exemplary embodiment, the alert system may include an alert processing means. The alert processing means takes the alerts that are queued for processing by the alert monitor (see FIG. 8) and checks them to determine if what the alert is looking for is now available. Each time the alert processor is run, it iterates through unprocessed alerts in its queue as follows: (1) it determines the alert type (e.g., flight or seat) and performs the applicable search for the alert type (same as the user generated search for the given search parameters) and (2) if the inventory or seat the alert is looking for is determined to be available or not. If it is not, the queue entry is set as “processed” and the processor moves on to the next alert. If it is, then the user is notified and the alert's status is changed from “pending” to “notified” in the database.

Additionally, concerning FIGS. 8 and 9, the process may be briefly summarized, and stated otherwise, as follows:

1. The user creates an alert and an entry is inputted into an “alerts” table.

2. The alert processor thread looks at the alert created by the user and determines the “alert_type_id” of the alert by looking at the “alert_type_mappings” table.

3. Then the alert processor thread takes the “alert_type_id” and looks at the “alert_algorithms” table to determine how often the alert should be checked based on how far out the departure date/time is.

4. If the “date_last_processed” is too long ago, an entry is put in the “alerts_queue” table so that the alert is checked, and “date_last_processed” is updated.

5. The alert queue processor thread, when it runs, looks at the “alerts_queue” table and sees what entries don't have a “date_started” entry, and checks the inventory/seats. A “flag_found” is set to “True” if inventory/seats are found for that queue entry.

6. If inventory/seats are found, the user is alerted (or whatever the potential action or notification is) and “alert_status_id” in the alerts table is updated to “Notified” status.

Therefore, the flight alerts provide the user with the capability to specify a flight segment with an upgrade or award class code for the currently available airlines for which upgrade/award inventory is visible. The user may have, for example, up to 30 flight and seat alerts active at any one time. This limit of 30 includes all alerts on the list, whether they are “Pending,” “Notified,” and/or “Expired.” “Pending” indicates that availability has not been found, but the process of polling the GDS continues. “Notified” indicates that availability has been found and an email notification has been sent to the addresses specified in the user's account. “Expired” indicates that availability has not been found and the flight is past its departure time. Thus, no more polling of the GDS take places.

Regarding the flight alerts, such flight alerts may be entered by using a “New Alert” entry screen that allows the user to specify the desirable flight segment and have some entity monitor such alerts, as described in FIG. 8 above. The user may enter a segment at any time prior to departure as long as the flight is currently in the airline's schedule for the specified date. Generally, this can be up to 330 days in advance of the date of departure, however, it could be more for some airlines. The user may also be permitted to set a threshold for the amount of available inventory to trigger an alert by using an “Available Quantity” drop down option. The entity handling such travel-related information may periodically poll one or more appropriate GDSs to determine if availability exists of at least the “Available Quantity” entered by the user. Once availability is found, the user is notified by, for example, email at all the email addresses entered into the user account section. Additionally, once an alert fires, besides an email notification, the system may initiate or perform additional operations. Such operations may include, but are not limited to, a booking operation, a booking change operation, an upgrade to an existing ticket operation, an award booking operation, or a seat assignment change operation. Of course, the notification may be sent to any type of electronic device, as defined herein.

Regarding the seat alerts, such seat alerts provide the user with the ability to save the locations of one or more favorite seat locations that are presently occupied on a particular flight. For example, if the user wishes to reserve a window seat with a particular airline, but there are no desirable window seats available, the user may enter the flight details in this function and inform the entity handling such travel-related information to periodically check to determine if a window seat becomes available. If a window seat is found, then a notification is sent to the user, for example, by email to any type of electronic device, as defined herein. Additionally, the user may specify one or more specific seat numbers and be notified if such seats become vacant. Seat occupancy is very dynamic on flights in all classes since occupancy status may change daily and more frequently as departure approaches. The software may be programmed to automatically increase polling activity of the flight closer to departure. As indicated above, the user may have up to a total of, for example, 30 seat and flight alerts at any given time. This limit of 30 includes all alerts on the list, whether they are “Pending,” “Notified,” and/or “Expired.”

Regarding both the flights alerts and the seat alerts, the user may be afforded more options. For instance, the user may have a “Quick Check” button option. The ‘Quick Check” button allows the user to execute a query to the GDS to determine if there is at least one flight or seat available that meets the criteria for the particular flight alert or seat alert. The user may also have a “Delete” button option. The “Delete” button option allows the user to delete flight alerts and seat alerts previously entered. The user may also have a “Resubmit” button option. The “Resubmit” button option allows the user to resubmit flight alerts and/or seat alerts for processing and return the status to “Pending.”

Alternatively, concerning the alert methodologies of FIGS. 8 and 9, the user may be able to enter multiple destinations for a search. For example, an alert may be provided to the user regarding flights from NYC to LAX or SFO or DTW, etc. In other words, multiple destination locations may be entered into the search criteria.

Alternatively, concerning the alert methodologies of FIGS. 8 and 9, the user may be able to enter multiple airlines for a search. For example, an alert may be provided to the user regarding Delta Airlines, JetBlue, and U.S. Airways regarding a specific destination.

Alternatively, concerning the alert methodologies of FIGS. 8 and 9, the user may be able to enter a range of dates for an alert. For example, an alert for a flight that satisfies at least one condition for any given date range may be provided.

Alternatively, concerning the alert methodologies of FIGS. 8 and 9, the user may be able perform a non-flight specific search. For example, an alert for any flight that satisfies at least one condition for any given day may be provided.

Alternatively, concerning the alert methodologies of FIGS. 8 and 9, the user may be able to resubmit requests for alerts. For example, if an alert was provided for any aisle seat and the two aisle seats that became available were deemed undesirable by the user, the user would be permitted to resubmit the alert request for any other aisle seat besides the two aisle seats initially presented to the user as options. Additionally, the user may resubmit an alert request to obtain, for instance, seats that are grouped together (e.g., if travelling with family). Thus, when a first result is submitted to the user, the user is permitted to re-submit at least one of a plurality of requests for alerts in order to receive a second result, the second result being different than the first result.

Alternatively, concerning the alert methodologies of FIGS. 8 and 9, the user may be able to receive an alert for inventory based on one leg (or segment) of multi-leg trip. For example, an alert for inventory on the ORD-HNL leg, when the overall trip is from JFK-ORD-HNL, requires the search to be performed for JFK→HNL and then look at the ORD-HNL inventory versus merely searching for the ORD-HNL leg of the trip. Such different requests may cause different inventory results.

Alternatively, concerning the alert methodologies of FIGS. 8 and 9, when an alert is checked for a flight on a given date, the database may be checked for other alerts for the same flight, and as such, may also be checked using the same data and all the alerts that the data is used to checked have their “date last processed” reset. As the usage of the system increases and more and more alerts are found for the same flight/day or other inventory or products, it would create an additional efficiency in that the cost per alert would decrease in the aggregate.

The above-described techniques may be implemented in digital electronic circuitry, or in computer hardware, firmware, software, or in combinations of them. The implementation may be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program may be written in any form of programming language, including compiled or interpreted languages, and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Embodiments as disclosed herein may also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Additionally, “code” as used herein, or “program” as used herein, or “software” as used herein, is any plurality of binary values or any executable, interpreted or compiled code which may be used by a computer or execution device to perform a task. This code or program may be written in any one of several known computer languages. The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above.

In addition, the present disclosure is not described with reference to any particular programming language. It is appreciated that a variety of programming languages may be used to implement the teachings of the present disclosure as described herein, and any references to specific languages are provided for disclosure of enablement and best mode of the present disclosure.

Methods may be performed and apparatus may be implemented by one or more programmable processors executing a computer program to perform functions of the techniques described above by operating on input data and generating output. Methods may also be performed by, and apparatus may be implemented as, special purpose logic circuitry, e.g., an FPGA (field programmable gate array) or an ASIC (application-specific integrated circuit). Modules may refer to portions of the computer program and/or the processor/special purpose logic circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks, as described and defined herein.

To provide for interaction with the user, the above described techniques may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer (e.g., interact with the user interface element). Other kinds of devices may be used to provide for interaction with the user as well; for example, feedback provided to the user may be any form of sensory feedback, e.g., visual feedback, auditory feedback, or tactile feedback; and input from the user may be received in any form, including acoustic, speech, or tactile input.

The above described techniques may be implemented in a distributed computing system that includes a back-end component, e.g., as a data server, and/or a middleware component, e.g., an application server, and/or a front-end component, e.g., a client computer having a graphical user interface and/or a Web browser through which the user may interact with an example implementation, or any combination of such back-end, middleware, or front-end components. The components of the system may be interconnected by any form or medium of digital data communication, e.g., a communication network. Examples of communication networks include a local area network (“LAN”) and a wide area network (“WAN”), e.g., the Internet, and include both wired and wireless networks.

Furthermore, although aspects of the present disclosure have been described herein in the context of several particular implementations in particular environments for particular purposes, those of ordinary skill in the art will recognize that its usefulness is not limited thereto and that the present disclosure may be beneficially implemented in any number of environments for any number of purposes.

It is to be understood, therefore, that this disclosure is not limited to the particular forms illustrated and that it is intended in the appended claims to embrace all alternatives, modifications, and variations which do not depart from the spirit and scope of the embodiments described herein.

It will be appreciated that variations of the above-disclosed and other features and functions, or alternatives thereof, may be desirably combined into many other different systems, methods or applications. Also, that various presently unforeseen or unanticipated alternatives, modifications, variations or improvements therein may be subsequently made by those skilled in the art which are also intended to be encompassed by the following claims.

1. A system for querying travel-related data, comprising:
a processor; and
a non-transitory, computer-readable storage medium in communication with the processor, wherein the computer-readable storage medium comprises one or more programming instructions for:
receiving a request for flight information;
searching a plurality of Global Distribution System (GDS) databases or at least one airline database directly in accordance with the request; and
sending at least one result from the plurality of GDS databases corresponding to the request, the at least one result including at least one of an available flight upgrade or an available flight award.

2. The system according to claim 1, wherein the request for flight information includes at least one of a flight upgrade request or a flight award request.

3. The system according to claim 1, wherein the one or more programming instructions further comprise sending the at least one result to a user via a web browser.

4. The system according to claim 1, wherein the one or more programming instructions further comprise providing the request for the flight information via a web browser.

5. The system according to claim 1, wherein the one or more programming instructions further comprise displaying the at least one result on a display.

6. The system according to claim 1, wherein the one or more programming instructions further comprise printing the at least one result via a printer.

7. The system according to claim 1, wherein the request for flight information includes at least one of a flight date, a flight date range, a flight time, a flight destination, a flight origination, a flight class, an upgrade class, an award class, and an airline.

8. The system according to claim 1, wherein the at least one result further includes at least one of an aircraft type, a frequency reliability, a description of an available flight upgrade, a description of an available flight reward, a number of seats for the available flight upgrade, and a number of seats for the available flight reward.

9. The system according to claim 1, wherein the one or more programming instructions further comprise:
querying the plurality of GDS databases for a plurality of available flight upgrades and a plurality of available flight awards; and
storing results from the querying of the plurality of GDS databases into a database.

10. The system according to claim 1, wherein the searching of the plurality of GDS databases is in response to an absence of the at least one available flight upgrade or the available flight award as specified by the request within a database.

11. The system according to claim 10, wherein the absence of at least one of a flight date, a flight date range, a flight time, a flight destination, a flight origination, a flight class, an upgrade class, an award class, and an airline within the database initiates the searching of the plurality of GDS databases.

12. The system according to claim 1, wherein the one or more programming instructions further comprise:
determining whether a database includes the at least one available flight upgrade or available flight award in accordance with the request;
querying one of the plurality of GDS databases in response to an absence of the at least one flight upgrade or flight award; and
storing a response from the queried GDS database in the database.

13. The system according to claim 1, wherein the one or more programming instructions further comprise determining which among the plurality of GDS databases to search based upon the request.

14. The system according to claim 1, wherein the at least one result includes the available upgrade or the available flight award.

15. The system according to claim 1, wherein the request for flight information includes a flight upgrade request corresponding to a plurality of destinations or a flight award request corresponding to the plurality of destinations, the at least one result including at least one of the available flight upgrade corresponding to the flight upgrade request or the available flight award corresponding to the flight award request.

16. The system according to claim 1, wherein the request for flight information includes a plurality of airline requests or a date range or a combination thereof.

17. The system according to claim 1, wherein the request for flight information includes an airline, wherein at least one of the available flight upgrades corresponds to a partner airline of the airline or at least one of the available flight awards corresponds to the partner airline of the airline.

18. The system according to claim 1, wherein the request for flight information and the searching of the plurality of GDS databases is performed continuously and in real time.

19. The system according to claim 1, wherein the request for flight information includes a request for an alert, the alert being a flight availability alert or a seat availability alert or a combination thereof, the alert taking place at predetermined time intervals.

20. The system according to claim 1, wherein the at least one result corresponding to the request is based on multiple destination inputs.

21. The system according to claim 1, wherein the at least one result corresponding to the request is based on multiple airline inputs.

22. The system according to claim 1, wherein a user is permitted to provide a range of dates pertaining to the flight information.

23. The system according to claim 1, wherein a user is permitted to search for the available flight upgrades or the available flight awards on a plurality of airlines accepting accumulated miles.

24. A system for querying travel-related data, comprising:
a processor; and
a non-transitory, computer-readable storage medium in communication with the processor, wherein the computer-readable storage medium comprises one or more programming instructions for:
receiving a plurality of requests for alerts on a flight concerning (i) availability of seat availability, (ii) availability of a flight upgrade, and (iii) availability of flight rewards;
monitoring the alerts at predetermined time intervals by searching Global Distribution System (GDS) databases or at least one airline database directly in accordance with the plurality of requests for alerts; and
sending at least one result from the plurality of GDS databases corresponding to the plurality of requests for alerts.

25. The system according to claim 24, wherein the one or more programming instructions further comprise sending alerts to a user via an email to a predetermined email address.

26. The system according to claim 24, wherein the one or more programming instruction further comprise determining whether to perform an additional search of the plurality of GDS databases in accordance with the plurality of requests for alerts based upon a predetermined search schedule.

27. The system according to claim 24, wherein after an alert is checked for a flight on a local database on a given flight date, the local database is checked for other alerts created by other users for the same flight.

28. The system according to claim 27, wherein as a number of alerts for the same flight increases, a cost per alert would decrease in the aggregate.

29. The system according to claim 24, wherein the one or more programming instructions further comprise indicating in the plurality of requests for alerts that each respective departed flight need not be searched.

30. The system according to claim 24, wherein the one or more programming instructions further comprise:
determining if a request for flight information has been searched in the plurality of GDS databases since a predetermined period of time, and
searching the plurality of GDS databases if the flight information has not been searched after the predetermined period of time.

31. The system according to claim 24, wherein the at least one result corresponding to the plurality of requests for alerts is based on multiple destination inputs.

32. The system according to claim 24, wherein the at least one result corresponding to the plurality of requests for alerts is based on multiple airline inputs.

33. The system according to claim 24, wherein a user is permitted to provide a range of dates for an alert.

34. The system according to claim 24, wherein a user is permitted to conduct a non-flight specific search and receive an alert for any flight that satisfies one or more conditions for any type of the flight information.

35. The system according to claim 24, wherein when a first result is submitted to a user, the user is permitted to re-submit at least one of a plurality of requests for alerts in order to receive a second result, the second result being different than the first result.

36. The system according to claim 24, wherein the alerts pertain to at least one leg of a trip having a plurality of legs.

37. A method for querying travel-related data, the method comprising:
receiving a request for flight information;
searching a plurality of Global Distribution System (GDS) databases or at least one airline database directly in accordance with the request; and
sending at least one result from the plurality of GDS databases corresponding to the request, the at least one result including at least one of an available flight upgrade or an available flight award.

38. The method according to claim 37, wherein the request for flight information includes at least one of a flight upgrade request or a flight award request.

39. The method according to claim 37, wherein the request for flight information includes at least one of a flight date, a flight date range, a flight time, a flight destination, a flight origination, a flight class, an upgrade class, an award class, and an airline.

40. The method according to claim 37, wherein the at least one result further includes at least one of an aircraft type, frequency, reliability, a description of an available flight upgrade, a description of an available flight reward, a number of seats for the available flight upgrade, and a number of seats for the available flight reward.

41. The method according to claim 37, wherein the request for flight information and the searching of the plurality of GDS databases is performed continuously and in real time.

42. The method according to claim 37, wherein the request for flight information includes a request for an alert, the alert being a flight availability alert or a seat availability alert or a combination thereof, the alert taking place at predetermined time intervals.

43. A method for querying travel-related data, the method comprising:
receiving a plurality of requests for alerts on a flight concerning (i) availability of seat availability , (ii) availability of a flight upgrade, and (iii) availability of flight rewards;
monitoring the alerts at predetermined time intervals by searching Global Distribution System (GDS) databases or at least one airline database directly in accordance with the plurality of requests for alerts; and
sending at least one result from the plurality of GDS databases corresponding to the plurality of requests for alerts.

44. The method according to claim 43, wherein the one or more programming instruction further comprise determining whether to perform an additional search of the plurality of GDS databases in accordance with the plurality of requests for alerts based upon a predetermined search schedule.

45. The method according to claim 43, wherein after an alert is checked for a flight on a local database on a given flight date, the local database is checked for other alerts created by other users for the same flight.

46. The method according to claim 45, wherein as a number of alerts for the same flight increases, a cost per alert would decrease in the aggregate.

47. The method according to claim 43, wherein the at least one result corresponding to the plurality of requests for alerts is based on multiple destination inputs.

48. The method according to claim 43, wherein the at least one result corresponding to the plurality of requests for alerts is based on multiple airline inputs.

49. The method according to claim 43, wherein a user is permitted to provide a range of dates for an alert.

50. The method according to claim 43, wherein a user is permitted to conduct a non-flight specific search and receive an alert for any flight that satisfies one or more conditions for any type of the flight information.

51. The method according to claim 43, wherein when a first result is submitted to a user, the user is permitted to re-submit at least one of a plurality of requests for alerts in order to receive a second result, the second result being different than the first result.
